(19) United States
(12) Patent Application Publication
(10) Pub. No.: US 2016/0088691 A1
(43) Pub. Date: Mar. 24, 2016

(54) MICROWAVE OVEN WITH VARIABLE CAVITY GEOMETRY OF COOKING CHAMBER

(71) Applicant: Dongbu Daewoo Electronics Corporation, Seoul (KR)

(72) Inventor: Gil Ju CHEONG, Incheon (KR)

(21) Appl. No.: 14/567,412

(22) Filed: Dec. 11, 2014

(30) Foreign Application Priority Data
Sep. 23, 2014 (KR) 10-2014-0126500

(51) Int. Cl. H05B 6/74; H05B 6/64

(52) U.S. Cl. CPC H05B 6/745; H05B 6/6402; H05B 6/6435

(57) ABSTRACT

Microwave oven system with enhanced microwave radiation uniformity in a cooking chamber. The microwave oven includes a stirrer installed outside the cooking chamber and operable to vary a cavity volume or a cavity shape of the cooking chamber while the stirrer rotates for more uniform food cooking. The stirrer may be disk-shaped and can simultaneously rotate and move vertically to change the cavity volume of the cooking chamber during operation. Alternatively, the stirrer may be installed in an inclined angle and can change the cavity shape of the cooking chamber when rotating.

### CROSS-REFERENCE TO RELATED APPLICATIONS

This application claims benefit and priority from Korean Patent Application No. 10-2014-0126500, filed on Sep. 23, 2014, with the Korean Intellectual Property Office, the disclosure of which is incorporated herein in its entirety by reference.

### TECHNICAL FIELD

The present disclosure relates to a microwave oven, and more particularly, to stirrers of microwave ovens.

### BACKGROUND

In general, a microwave oven radiates microwaves to excite molecular vibration in food and beverages (hereinafter, referred to as “food”) and thereby heat up the food quickly.

A microwave usually applies a high voltage to a magnetron to generate the microwaves which are delivered to the cooking chamber through a waveguide.

Unfortunately, since the microwaves are radiated from a source of a small spatial volume (e.g. at the exit of the waveguide), the wave energy distribution is naturally non-uniform across the cooking chamber. Thus, food having a relatively large volume cannot be evenly heated.

### SUMMARY

Therefore, it would be advantageous to provide a microwave oven capable of evenly heating food placed inside a cooking chamber.

Embodiments of the present disclosure provide a microwave oven equipped with a stirrer operable to dynamically vary the cavity geometry of the microwave during operation. The dynamic variation of the cavity geometry leads to a more uniform energy distribution in the cooking chamber. Thereby, the microwave can heat up the food evenly.

According to an embodiment of the present disclosure, a microwave oven includes a cooking chamber in which cooking is performed by using microwaves; a stirrer accommodating part formed at one side of the cooking chamber and exposed to the cooking chamber; a microwave radiating unit configured to radiate microwaves into the cooking chamber; and a rotatable stirrer installed in the stirrer accommodating part and configured to vary a cavity volume or a shape of the cooking chamber while rotating.

The stirrer may vertically move while rotating to vary the cavity volume of the cooking chamber.

The microwave oven may further include a stirrer cover part coupled to the stirring accommodating part and configured to cover the stirrer. A ring-shaped height variable rail in an alternately inclined-declined configuration against a vertical direction may be installed on one surface of the stirrer cover part and facing the stirrer. Protrusion bars, which vertically move the stirrer while moving along the height variable rail, may be disposed on one surface of the stirrer facing the stirrer cover part.

A protrusion bar may have a length in a direction orthogonal to the height variable rail. The plurality of protrusion bars may be radially disposed relative to the center of the ring-shaped height variable rail.

The height variable rail may be in contact with a center point in a longitudinal direction of the protrusion bar.

The stirrer is configured to have an inclined angle relative to the horizontal orientation and operable to vary the shape of the cooking chamber when it rotates.

The stirrer may be isolated from the cooking chamber by a stirrer cover part.

The stirrer cover part may be formed of a non-conductor material.

Another exemplary embodiment of the present disclosure provides a cooking method using a microwave oven, including: accessing a cooking time set by a user; radiating microwaves to the cooking chamber according to the cooking time; and varying a cavity volume or a shape of the cooking chamber when the microwaves are radiated into the cooking chamber.

The cavity volume or the shape of the cooking chamber may be dynamically varied while a stirrer installed at one side of the cooking chamber rotates.

The stirrer may move vertically while rotating to vary the cavity volume of the cooking chamber.

The stirrer may be inclined relative to the horizontal orientation and operable to vary the shape of the cooking chamber when rotating.

According to the exemplary embodiments of the present disclosure, the microwave oven and the cooking method using the same may evenly heat food inside a cooking chamber by varying a waveform of microwaves.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates the configuration of an exemplary microwave oven according to a first exemplary embodiment of the present disclosure;

FIG. 2 is an exploded perspective view based on an exemplary stirrer of FIG. 1;

FIG. 3 is a top plan view of the exemplary stirrer of FIG. 1;

FIG. 4 is a cross-sectional view of an exemplary stirrer of a microwave oven according to a second exemplary embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

Microwave Oven with Variable Cavity Geometry of Cooking Chamber

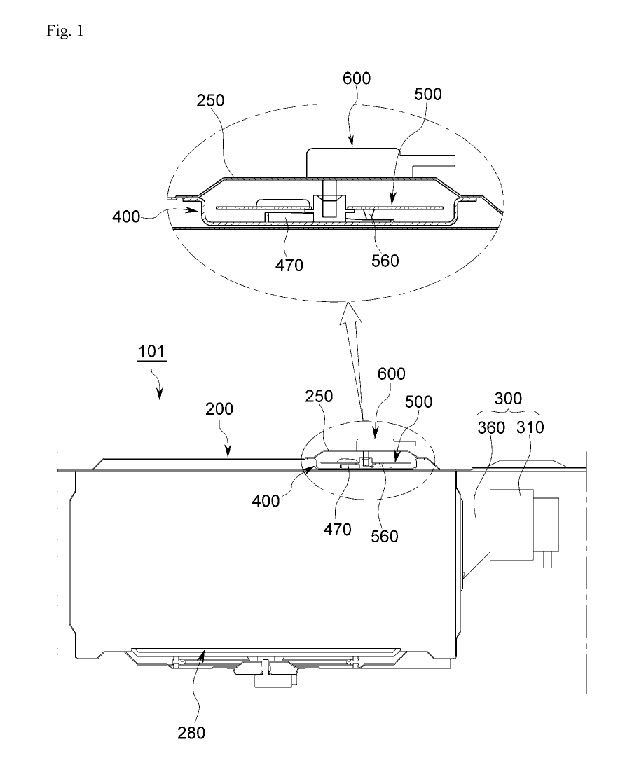

Hereinafter, a microwave oven 101 according to a first exemplary embodiment of the present disclosure will be described with reference to FIGS. 1 to 3.

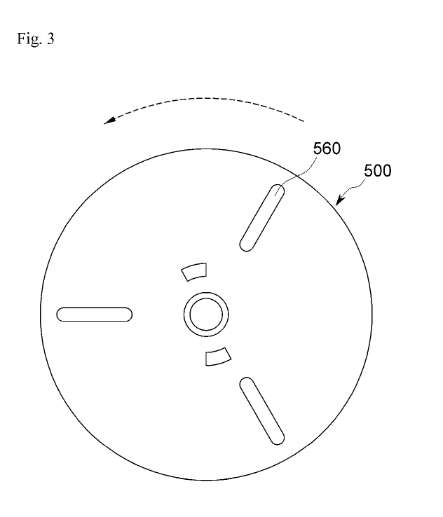

As illustrated in FIGS. 1 and 3, the microwave oven 101 includes a cooking chamber 200, a microwave radiating unit 300, and a stirrer 500 (or a stirrer fan).

The microwave oven 101 further includes a driving motor 600 and a stirrer cover part 400.

The cooking chamber 200 is rectangular box-shaped and formed of a conductive material and can accommodate food to heat it.

The cooking chamber 200 includes an opening through which food is placed in and out, and a tray 280 to support the food. The tray is rotatably installed on a lower surface of the cooking chamber 200.

In the first exemplary embodiment of the present disclosure, a stirrer accommodating part 250 is installed on one side of the cooking chamber 200, e.g., inside the top wall of the microwave oven 101. The microwave radiating unit 300 is installed on another side of the cooking chamber 200 to radiate microwaves into the cooking chamber 200. In this example, the microwave radiating unit 300 is installed in a side wall of the microwave oven 101.

The microwave radiating unit 300 radiates microwaves into the cooking chamber 200 through a plurality of radiation holes formed on the surface of the side wall of the microwave oven 101. In this example, each radiation hole has a dimension equal to or greater than ¼ of a wavelength of the microwaves. It is appreciated that generally a microwave cannot efficiently pass through radiation holes smaller than ¼ of its wavelength.

The microwave radiating unit 300 includes a magnetron 310 to generate microwaves, and a waveguide 360 installed between the magnetron 310 and the cooking chamber 200. The waveguide 360 serves as a conduit to guide microwaves from the magnetron 310 and the cooking chamber 200.

The magnetron 310 receives high-voltage power from a high-voltage transformer and generates microwaves.

The stirrer 500 is rotatably installed in the stirrer accommodating part 250.

In the first exemplary embodiment of the present disclosure, the stirrer 500 moves vertically while rotating and thereby effectively varies the volume of the cooking chamber subject to microwave radiation.

As described above, in the microwave oven 101, the stirrer 500 varies the cavity of the cooking chamber 200 to change a wavelength of the microwaves radiated from the microwave radiating unit 300. Accordingly, the microwaves irradiated into the cooking chamber 200 are distributed with enhanced uniformity and thus can evenly heat up food inside the cooking chamber 200.

The stirrer 500 is configured to avoid contact with the cooking chamber 200 while the stirrer 500 vertically moves while rotating. The stirrer 500 may be circular disk shaped.

The driving motor 600 rotates the stirrer 500. A rotation axis of the driving motor 600 is coupled to a center of the stirrer 500 to rotate the stirrer 500.

The stirrer cover part 400 is coupled to the stirrer accommodating part 250 to cover the stirrer 500 so that the stirrer 500 does not touch the food accommodated in the cooking chamber 200.

In the first exemplary embodiment of the present disclosure, the stirrer cover part 400 includes a ring-shaped height variable rail 470 having alternate inclined sections and declined sections with reference to a vertical direction on the surface facing the stirrer 500. For example, the height variable rail 470 may be wave-like shaped.

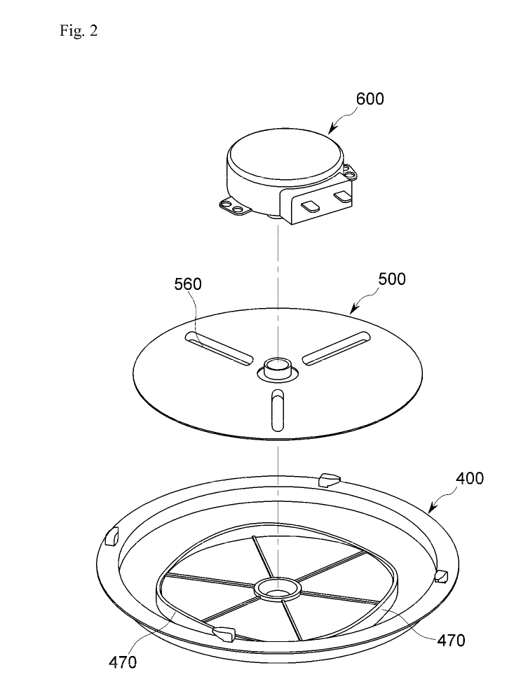

As shown in FIG. 2, the stirrer 500 includes protrusion bars 560 moving along the height variable rail 470 on the surface facing the stirrer cover part 400. Here, as the protrusion bars 560 moves along the height variable rail 470, the stirrer 500 is caused to repeatedly move up and down.

Each protrusion bar 560 may extend in a radial direction of the height variable rail 470. The plurality of protrusion bars 560 may be disposed along various radii of the ring-shaped height variable rail 470, or orthogonal to the rail 470. In this example, the height variable rail 470 is configured to be in contact with the middle of each protrusion bar 560.

The stirrer accommodating part 250 is disposed on the upper surface of the cooking chamber 200 and the stirrer cover part 400 covers the stirrer 500 at a lower position. The stirrer 500 is rotated by the driving motor 600 and simultaneously moves vertically as driven by the height variable rail 460 in conjunction with the stirrer accommodating part 400.

More particularly, the plurality of protrusion bars 560 are radially arranged and extend in the directions crossing the height variable rail 470. The protrusion bars 560 move vertically while being in contact with the ring-shaped height variable rail 470. As such, even through the drive is applied from the outside or coupling between the stirrer cover part 400 and the stirrer accommodating part 250 is shallow, the protrusion bars 560 may continuously make the stirrer 500 move vertically without being derailed from the height variable rail 470.

As described above, the stirrer 500 moves vertically while rotating, resulting in the dynamic variation of the cavity volume of the cooking chamber 200, and thereby changing the wavelengths of the microwaves radiated into the cooking chamber 200. Thus, it is appreciated that the microwaves radiated into the cooking chamber 200 are uniformly delivered to food placed inside the cooking chamber 200.

The stirrer cover part 400 is made of non-conductive material to avoid interference with the microwaves. The stirrer cover part 400 can also electrically insulate the stirrer 500 from the cooking chamber 200.

According to the aforementioned configuration, the microwave oven 101 according to the first exemplary embodiment of the present disclosure changes the waveforms of the microwaves by varying the cavity of the cooking chamber 200, thereby advantageously evenly heating food inside the cooking chamber 200.

Hereinafter, a cooking method using the microwave oven 100 according to the first exemplary embodiment of the present disclosure will be described.

First, food desired to be cooked is placed into the cooking chamber 200, and a cooking time is set according to a cooking method and the type of food.

Next, microwaves are radiated into the cooking chamber 200 according to the set cooking time.

When the microwaves are radiated into the cooking chamber 200, the cavity volume of the cooking chamber is varied. In this case, the cavity volume of the cooking chamber 200 is dynamically varied when the stirrer 500 installed at one side of the cooking chamber 200 rotates and moves vertically.

As described above, according to the cooking method using the microwave oven 101 of the first exemplary embodiment of the present disclosure, the waveforms of the microwaves are modified by using the stirrer 500 to vary the cavity of the cooking chamber 200. As a result, the food placed inside the cooking chamber 200 can be evenly heated.

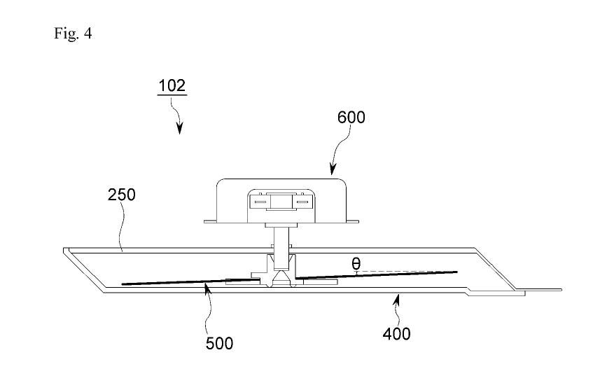

Hereinafter, a microwave oven 102 according to a second exemplary embodiment of the present disclosure will be described with reference to FIG. 4.

As illustrated in FIG. 4, the microwave oven 102 according to the second exemplary embodiment of the present disclosure includes a stirrer 500 installed with an inclined angle with reference to the horizontal orientation.

That is, in the second exemplary embodiment of the present disclosure, the stirrer 500 does not vertically move while rotating. Instead, the stirrer 500 is installed to be inclined by an angle θ and not parallel to any major surface of the cooking chamber 200. As described above, while the stirrer 500 rotates, the cavity of the cooking chamber 200 continuously change due to the inclined orientation, thereby changing the waveforms of the microwaves reflected to the stirrer 500.

Accordingly, in the second exemplary embodiment of the present disclosure, a height variable rail 470 may not be needed in the stirrer cover part 400.

The configuration of the second exemplary microwave is the same as that of the first exemplary microwave except for the stirrer 500 and the stirrer cover part 400. Thus, detailed descriptions thereof are omitted.

According to the second exemplary embodiment of the present disclosure, the stirrer 500 does not vary the cavity volume of the cooking chamber 200, but continuously changes a geometric shape of the cavity of cooking chamber 200. Thus, the boundary condition for microwave radiation is changed continuously, thereby changing the waveform of the microwaves. Accordingly, the microwaves irradiated into the cooking chamber 200 may advantageously be uniformly transferred to the food inside the cooking chamber 200.

According to the aforementioned configuration, the microwave oven 102 according to the second embodiment of the present disclosure can also change the waveforms of the microwaves inside the cooking chamber 200, thereby evenly heating food inside the cooking chamber 200.

Hereinafter, a cooking method using the microwave oven 102 according to the second exemplary embodiment of the present disclosure will be described.

First, food desired to be cooked is inserted into the cooking chamber 200, and a cooking time is set according to a cooking method and the type of food.

Next, microwaves are radiated into the cooking chamber 200 according to the set cooking time.

The microwaves vary the shape of the cooking chamber when being transmitted into the cooking chamber 200. In this case, the cavity shape of the cooking chamber 200 is varied while the stirrer 500 installed on one side of the cooking chamber 200 rotates.

More particularly, the stirrer is installed with an inclined angle and can change the geometric shape of the cooking chamber.

As described above, by using the cooking method using the microwave oven 102 according to the second exemplary embodiment of the present disclosure, it is possible to change the waveforms of the microwaves by continuously varying the geometric shape of the cooking chamber 200, thereby evenly heating the food inside the cooking chamber 200.

The exemplary embodiments of the present disclosure have been described with reference to the accompanying drawings, but those skilled in the art will understand that the present disclosure may be implemented in another specific form without changing the technical spirit or an essential feature thereof.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A microwave oven, comprising:
a cooking chamber;
a stirrer accommodating part disposed at one side of the cooking chamber;
a microwave radiating unit configured to radiate microwaves into the cooking chamber; and
a stirrer installed in the stirrer accommodating part and configured to vary a cavity geometry of the cooking chamber while the stirrer rotates.

2. The microwave oven of claim 1, further comprising:
a driving motor coupled to the stirrer and configured to rotate the stirrer.

3. The microwave oven of claim 1, wherein the stirrer vertically moves while rotating to vary the cavity volume of the cooking chamber.

4. The microwave oven of claim 3, further comprising:
a stirrer cover part coupled to the stirring accommodating part and configured to cover the stirrer; and
a ring-shaped height variable rail in an alternately inclined and declined configuration against a vertical orientation and disposed on one surface of the stirrer cover part and facing the stirrer,
wherein the stirrer comprises protrusion bars coupled to the ring-shaped height variable rail and configured to cause the stirrer to move vertically as the protrusion bars move on the height variable rail, wherein the protrusion bars face the stirrer cover part.

5. The microwave oven of claim 4, wherein each protrusion bar extends in a direction orthogonal to the height variable rail, and wherein further the protrusion bars are arranged along various radial directions relative a center of the height variable rail.

6. The microwave oven of claim 5, wherein the height variable rail is configured to contact a center of the protrusion bar.

7. The microwave oven of claim 1, wherein the stirrer is configured to be inclined with reference to a horizontal orientation and is operable to vary a cavity geometric shape of the cooking chamber when the stirrer rotates.

8. The microwave oven of claim 1, wherein the stirrer is disposed outside the cooking chamber.

9. The microwave oven of claim 1, wherein the stirrer cover part is formed of a non-conducting material.

10. A method of cooking using a microwave oven, the method comprising:
accessing a cooking time requested by a user;
radiating microwaves into the cooking chamber according to the cooking time; and
varying a cavity geometry of the cooking chamber during the radiating.

11. The cooking method of claim 10, wherein the varying the cavity volume comprises varying a cavity volume or a cavity geometric shape of the cooking chamber by moving a stirrer.

12. The cooking method of claim 11 further comprising simultaneously rotating the stirrer and moving the stirrer vertically to vary the cavity volume of the cooking chamber.

13. The cooking method of claim 11, wherein varying the cavity geometric shape comprises simultaneously rotate the stirrer that has an inclined angle with reference to a horizontal orientation.
